(19) United States
(12) Patent Application Publication
(10) Pub. No.: US 2014/0025508 A1
(43) Pub. Date: Jan. 23, 2014

(54) ADVERTISING SYSTEMS AND METHODS

(71) Applicant: Brent Bartosch, Santa Monica, CA (US)

(72) Inventor: Brent Bartosch, Santa Monica, CA (US)

(21) Appl. No.: 13/825,659

(22) PCT Filed: Sep. 21, 2011
(86) PCT No.: PCT/US11/52579

§ 371 Date: Sep. 9, 2013

Related U.S. Application Data
(60) Provisional application No. 61/385,312, filed on Sep. 22, 2010.

(51) Int. Cl. G06Q 30/02; G09F 23/06

(52) U.S. Cl. CPC G06Q 30/0241; G09F 23/06
USPC 705/14.69; 426/87; 53/473; 40/538; 705/14.4

(57) ABSTRACT

An advertising unit includes a container and a flat divider dividing the container into two compartments. The divider is separate from the container and unable to support itself in an upright orientation. The divider includes an advertising display. A comestible product, such as soft-serve ice cream or frozen yogurt, is in the container on opposite sides of the divider and supports the divider in a generally upright position. Methods of advertising include placing advertising on the divider and providing the divider to a vendor of the comestible product. The advertising unit and advertising methods can be used to increase the impact of advertising by encouraging people consuming the product from the container to interact physically with the divider and creating a positive association between the advertising message and the experience of eating a desired comestible product.

### FILED OF INVENTION

The present invention relates generally to systems and methods for advertising, and in particular to systems and methods for enhancing the impact and value of advertising by associating it with a positive experience of consuming a comestible product and/or providing the advertising on structure and under conditions that encourage a member of the target audience to physically interact with the structure to increase the impact of the advertising.

### BACKGROUND

Self-serve frozen yogurt has grown in popularity in recent years. The yogurt can be tart or sweetened and can be made in different flavors. Self-serve frozen yogurt vendors often provide containers (e.g., cups or bowls) into which customers dispense frozen yogurt. The containers are often disposable items and add to the vendors' costs. Because vendors have a strong desire to contain costs, the disposable cups and bowls are typically constructed to facilitate compact nested stacking of the containers to reduce space occupied by the cups or bowls. There is also a strong economic pressure to use disposable cups or bowls that can be manufactured efficiently. Thus, these cups and bowls are generally simple in their construction. Although there are containers in the art that have integrally formed dividers forming multiple compartments, these multi-compartment containers are more complicated to manufacture and are difficult to stack efficiently. Thus, multi-compartment containers having integrally formed dividers are generally not used in the frozen yogurt and ice cream business, in part because of the their higher costs.

### SUMMARY

One aspect of the invention is an advertising unit. The unit includes a container and a flat divider dividing the container into two compartments. The divider is formed separately from the container and unable to support itself in an upright orientation. The divider includes an advertising display. A comestible product is in the container on opposite sides of the divider and supports the divider in a generally upright position.

Another aspect of the invention is a method of advertising. The method includes identifying a container provided to a customer by a vendor of self-serve frozen desserts for use holding a frozen dessert assembled by the customer. Advertising is placed on a flat divider that is unable to support itself in an upright orientation. The divider is configured to match the shape of the container such that the vendor's customer can place the divider into the container and divide it into two compartments and so the divider can be held in an upright position by the self-serve frozen dessert. The divider is provided to the vendor.

Still another aspect of the invention is a method of enhancing the impact of a brand message and associating the brand with a positive experience for at least one member of a target audience for the brand message. The method includes positioning a flat divider that is formed separately from a container and unable to support itself in an upright position and on which the brand message is displayed into the container so the divider divides the container into two compartments. The container is at least partially filled with a frozen dessert product so after the placing and filling steps, frozen dessert product is in each of the compartments and helps retain the divider in an upright position in the container.

Other objects and features will in part be apparent and will in part be pointed out hereinafter.

### BRIEF DESCRIPTION OF THE DRAWINGS

FIG. 1 is a top plan view of one embodiment of a divider for an advertising unit;

FIG. 2 is a perspective of the divider;

FIG. 3 is a perspective of a container for receiving the divider;

FIG. 4 is a side elevation of the divider;

FIG. 5 is a top plan view of an advertising unit formed by inserting the divider into the container;

FIG. 6 is a perspective of the advertising unit;

FIG. 7 is a perspective of the advertising unit containing a comestible product and toppings and including a lid that can be placed on the container while the divider is in the container;

FIG. 8 is a perspective of the advertising unit similar to FIG. 7 but with a different lid;

FIG. 9 is a flow diagram illustrating the steps in one embodiment of a method of advertising; and

FIG. 10 is a flow diagram illustrating the steps in another embodiment of a method of advertising.

Corresponding reference characters indicate corresponding parts throughout the drawings.

### DETAILED DESCRIPTION

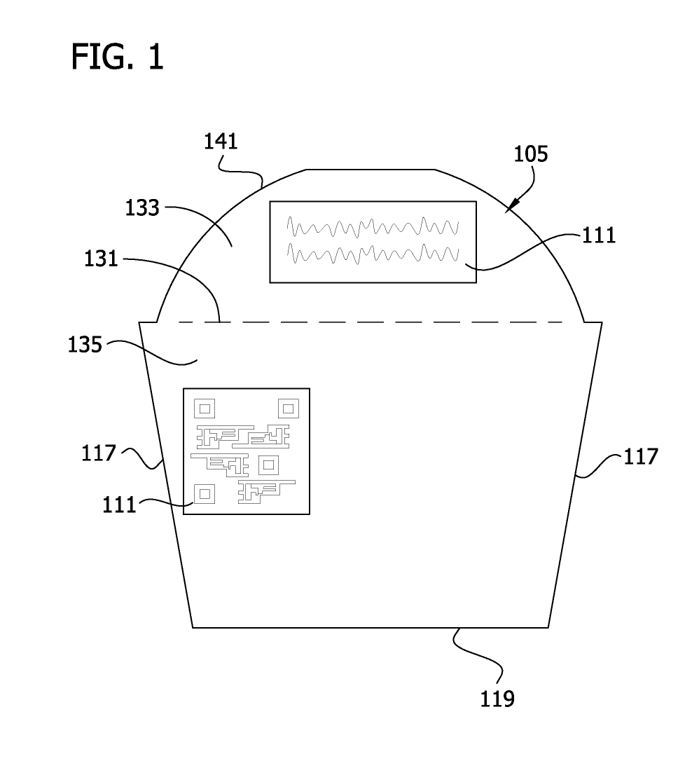

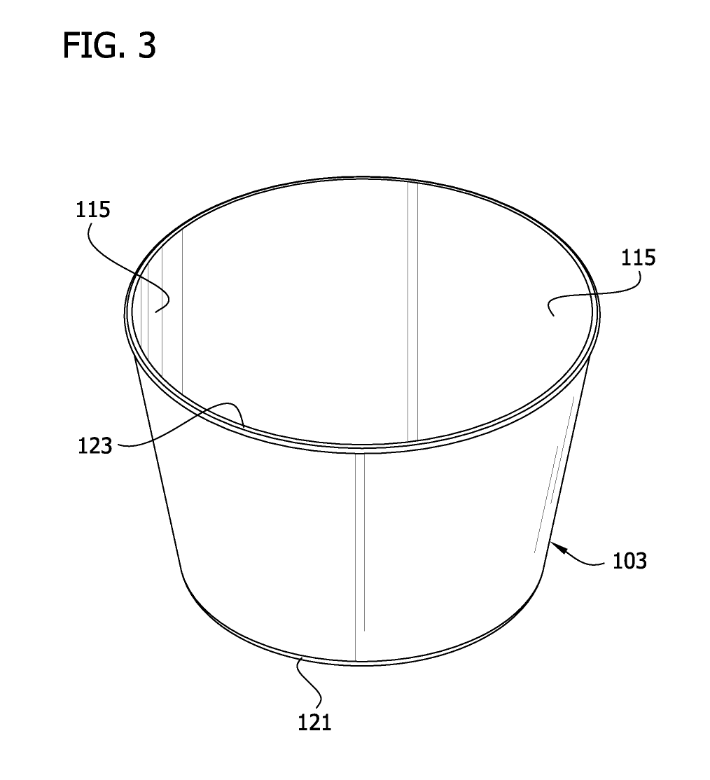

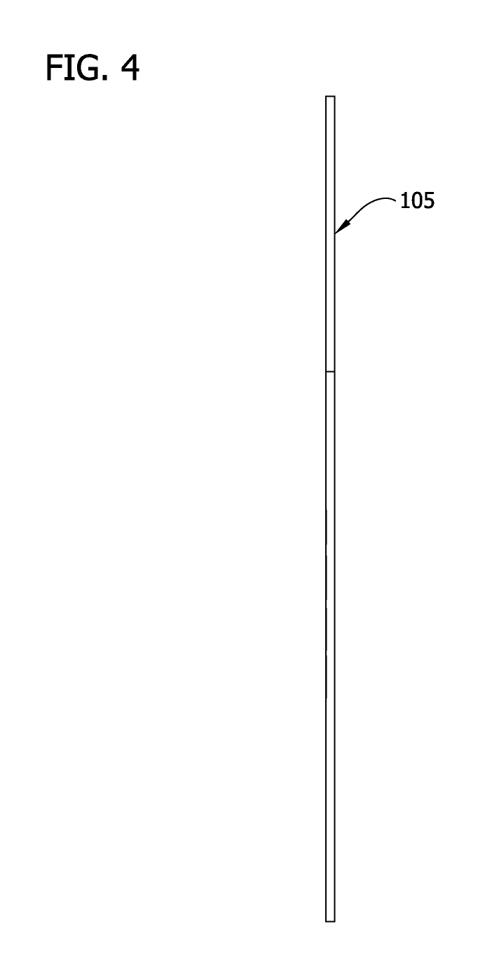

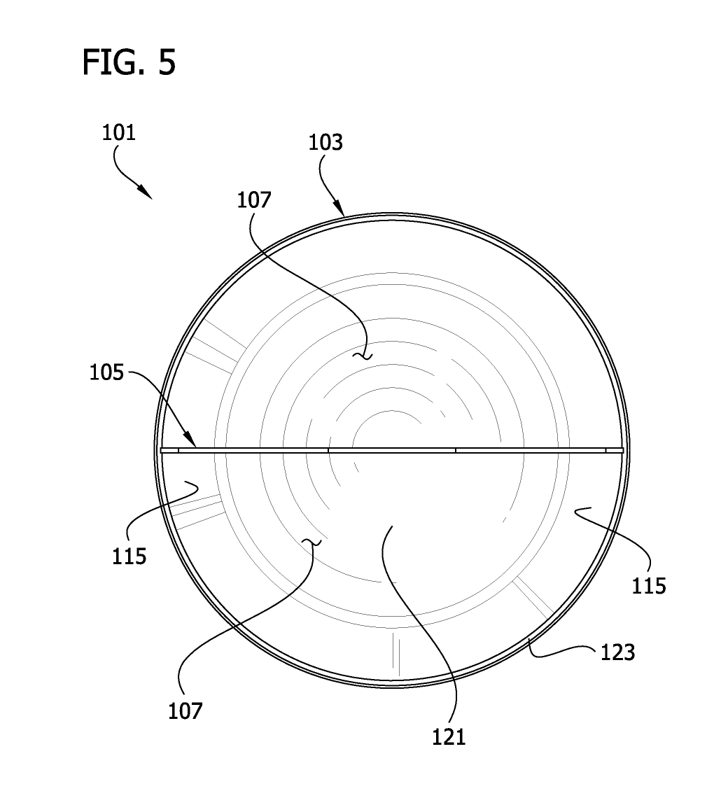

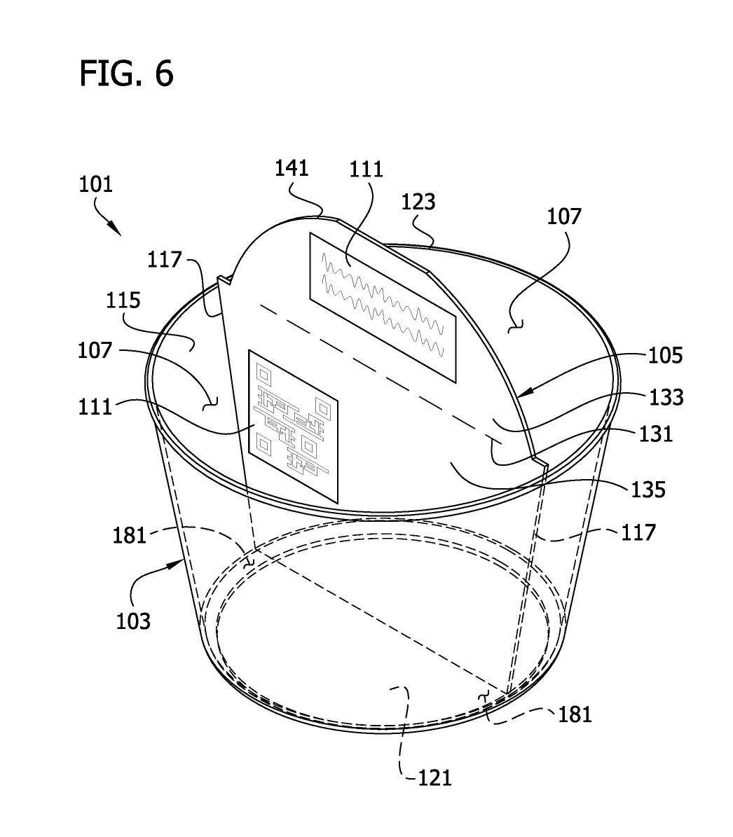

Referring to the drawings, first to FIGS. 1-8, one embodiment of an advertising unit of the present invention, generally designated 101, includes a container 103 (e.g., a cup or bowl) and a divider 105 adapted to divide the cup into two compartments 107. The compartments 107 can be about equal in size and shape (e.g., mirror images of one another), as illustrated, but this is not required. As illustrated, the container 103 is a cup. The container can have various sizes and shapes within the broad scope of the invention.

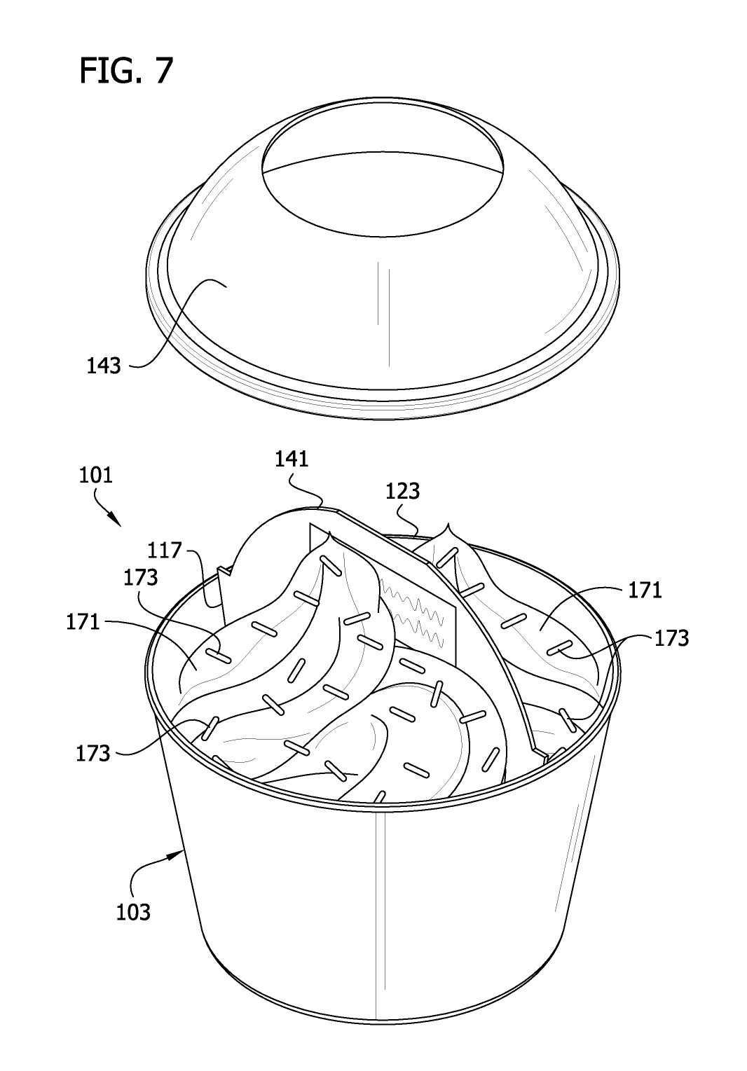

The container 103 holds a comestible product 171 in each compartment 107, as illustrated in FIG. 7. The comestible product can also vary within the broad scope of the invention. For example, the comestible product can suitably include ice cream (e.g., soft-serve ice cream), yogurt, frozen yogurt, frozen custard, and/or another dessert product. The particular cup 103 illustrated in the drawings has the same size and shape as the cups that are very commonly provided to customers by self-serve frozen yogurt vendors for use in holding the desserts the customers construct and which can also be used by vendors that serve customers frozen yogurt or similar products already in cups in response to customer orders. Toppings 173 including various nuts, cereal, fruit, candy, and/or flavored syrups can optionally be added to the top of the comestible product 171. The contents of the compartments 107 can be different from one another (e.g., have different flavors and/or different toppings), although it is contemplated the compartments can hold identical comestible products within the scope of the invention.

The divider 105 is suitably formed from a flat sheet of food-safe material that is formed separately from (e.g., unattached to) the container 103 so the divider can move relative to the container. For example, the divider 105 can be constructed of a sheet of sturdy paper protected by a layer of wax or other liquid barrier (e.g., similar to the materials used to construct paper milk containers). The divider 105 has an outer perimeter sized and shaped to be received in the container 103. The container 103 has opposing inner sides 115 tapering from a wider top to a narrower bottom and the divider 105 has opposite outer side edges 117 in conformal engagement with at least segments of the inner sides of the container. The side edges 117 of the divider 105 shown in the drawings are configured to extend along the inner sides 115 of the cup 103 all the way from the bottom 119 of the divider at or near the bottom 121 of the cup to a position at or above the top 123 of the cup. In the illustrated embodiment, the divider 105 is configured to extend above a top of the container 103 when the bottom edge 119 of the divider contacts the bottom 121 of the container.

The advertising unit 101 in the drawings has a divider 105 having a bottom edge 119 that is substantially straight and which does not conform precisely to the dome-shaped bottom 121 of the cup 103. This straight bottom edge 119 is an artifact from a process of making the divider 105 by folding a sheet of material along a fold line coinciding with the bottom edge. For instance, advertisements 111 can be printed on one side of a sheet of paper that is folded over on itself along a fold line coinciding with the bottom 119 of the divider 105 to make a double layer paper sheet, which is laminated to hold the layers of paper together to produce the divider. This facilitates placement of advertising 111 on both sides of the divider 105 while requiring only one pass of the material used to make the divider through a single-sided printing machine. Although there are slight gaps 181 between the bottom 119 of the divider 105 and the bottom of the cup 103 at the side edges 117 of the divider because the bottom of the divider is not shaped to conform precisely to the bottom of the cup, the divider provides substantial separation between the compartments 107. If it is desirable for minimizing the size of any gaps between the divider and the bottom of the cup, or for any other reasons, it is possible to make the bottom of the divider so it is shaped to conform more precisely to the bottom of the cup within the scope of the invention. For instance, the bottom edge of the divider can suitably have a concave shape having a curvature generally matching the curvature of the bottom of the cup. It is also possible to use the divider 105 having a flat bottom edge 119 with a cup having a flat bottom (not shown) to minimize gaps within the scope of the invention.

The divider 105 suitably includes one or more advertisements 111 or other brand messages displayed on the divider 105. Advertisements 111 can be placed on the upper portion of the divider (e.g., the portion extending above the top of the cup 103) where they are more likely to be visible when the cup 103 is full. However, some or all of the advertisements may be positioned lower on the divider where they can be covered and obscured initially by the comestible product within the scope of the invention. In some cases, it may be desirable to place advertisements where they will initially be obscured by the comestible product and revealed as the comestible product is consumed. The advertisements 111 can be printed, written, punched, pressed, stamped, or otherwise placed on the divider 105 during manufacture of the divider. Any ink used in the advertisement 111 is suitably a food-safe ink. Also, by constructing the divider so the folded edge forms the bottom, side edge, or top of the divider the divider can be made more resistant to absorption of liquid at the folded edge. It is also contemplated one or more of the inks used to place advertisements 111 on the divider 105 may have temperature-activated color change properties. For example, thermochromatic inks that change color in response to temperature changes can be obtained from Chromatic Technologies, Inc. of Colorado Springs, Colo.

The cup 103 and divider 105 are suitably adapted to encourage the consumer to physically interact with the divider while consuming comestible material 171 from the unit 101 formed by the combination of the cup and divider. In the illustrated embodiment, for example, the flat divider 105 is unattached to the container 103, which provides opportunities for the divider to be moved relative to the container. Further, the flat divider 105 is unable to support itself in an upright position. The side edges 117 of the divider 105 may receive some support from the sides 115 of the container 103, but the divider 105 in the illustrated embodiment is constructed to permit some lateral movement of the divider within the container 103 and the divider is suitably not tightly wedged between the sides 115 of the container 103. For example, the divider 105 is suitably constructed of a material that can flex at least slightly to enable the sides edges 117 of the divider to be compressed toward one another as the divider moves laterally from the diameter of the container 103. The flexibility of the divider 105 is suitably selected to enable the divider to be readily deformed (e.g., by a force that the divider is expected to encounter during use by a consumer) and moved by the consumer yet stiff enough to provide a benefit to a consumer who wants to divide the container into compartments 107.

When the comestible product 171 is in the container 103 on opposite sides of the divider 105, the comestible product helps support the divider in a generally upright position. Although it is contemplated the divider 105 might not form a complete seal between the two compartments 107, it is still possible for a consumer to maintain reasonable separation between different comestible products 171 in the compartments if this is what the consumer desires. As the comestible product 171 is consumed, the product provides less support to the divider 105, which increases the likelihood the divider will be moved.

The divider 105 can be moved by incidental contact by the consumer as the consumer consumes the comestible product 171. For example, when using a spoon or other utensil (not shown) to reach into the bottom of the compartments 107 the utensil can push against the divider 105 and move it. If the bottom of the divider 105 is pushed, for instance, this can cause the divider to tilt in the container 103. The opportunity for the consumer to move the divider 105 is not limited to movement caused by incidental contact. The consumer may also intentionally move the divider 105 back to its original position after accidentally moving it, may intentionally move the divider to gain improved access to one of the compartments 107, and/or may move or fiddle with the divider for idle amusement.

The ability to move the divider 105 while consuming the product 171 makes the divider a dynamic component which will generally receive more attention from the consumer than a static component. When the consumer looks at the divider 105 while moving it or to decide whether or not to move the divider, the consumer is exposed to the advertising 111. Also, because the consumer controls, at least for the most part, how and when to move the divider 105 and because people generally enjoy being in control, the consumer may associate the divider with additional positive feelings, which when combined with the positive feelings from the overall experience may form a stronger positive association between the consumer and the advertising (e.g. brand) message 111 on the divider. The divider 105 also provides the consumer with the option to have different combinations of comestible product 171 (e.g., different flavors, toppings, etc.) in the different compartments 107. This is another element of control by the consumer and the ability to have two desired products 171 in different compartments 107 instead of just one can also increase the amount of pleasure for the consumer. These factors can also contribute to forming a strong positive association between the consumer and the advertising message 111 on the divider 105.

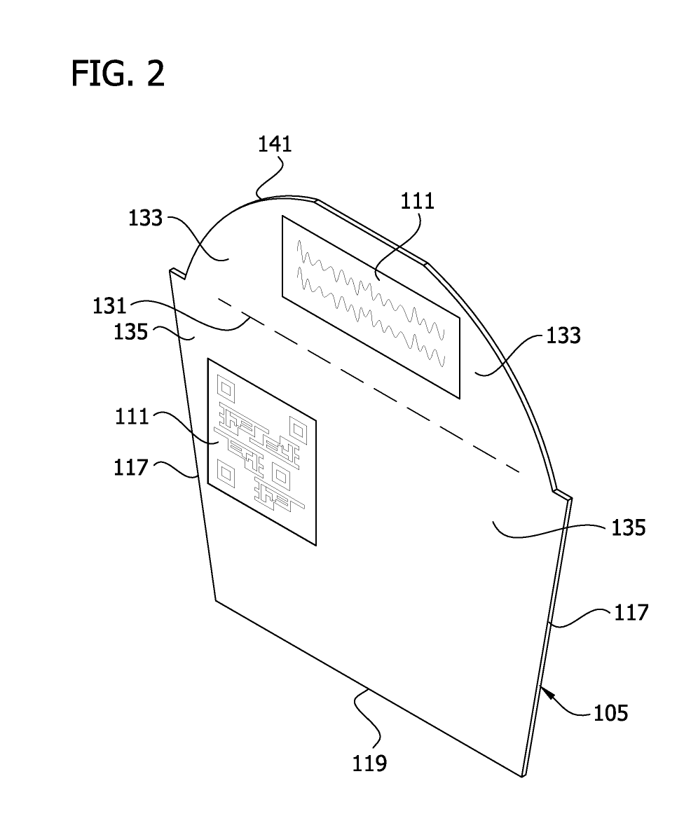

Additional promotional features may be incorporated into the divider 105. For example, FIGS. 1 and 2 illustrate perforations 131 provided in the divider 105 separating a tear-off portion 133 of the divider from a main body 135 of the divider. The tear off portion 133 of the divider 105 can be, for example, one or more of the following: a structure displaying one or more of the advertisements 111; a piece in a promotional game or contest; a proof of purchase for a rewards program; a barcode (e.g., a smart phone readable one-dimensional or two-dimensional/matrix barcode including but not limited to QR Code, Code 39, Code 128, UPC-A, APC-E, EAN-13, Datamatrix, Aztec Code and BeeTagg); and a coupon. As illustrated in the FIG. 7, the divider 105 has an upper edge 141 shaped to conform to and extend along the underside of an optional lid 143 (e.g., dome shaped or truncated dome shaped lid) that may be secured to the top of the cup 103. The consumer can detach the tear off portion 133 from the rest of the divider 135 before filling the container 103 with comestible product 171 or before discarding the container and main body of the divider after use (e.g., to keep only the tear off portion 133 for later use of the tear off portion as a coupon, game piece, proof of purchase, etc.).

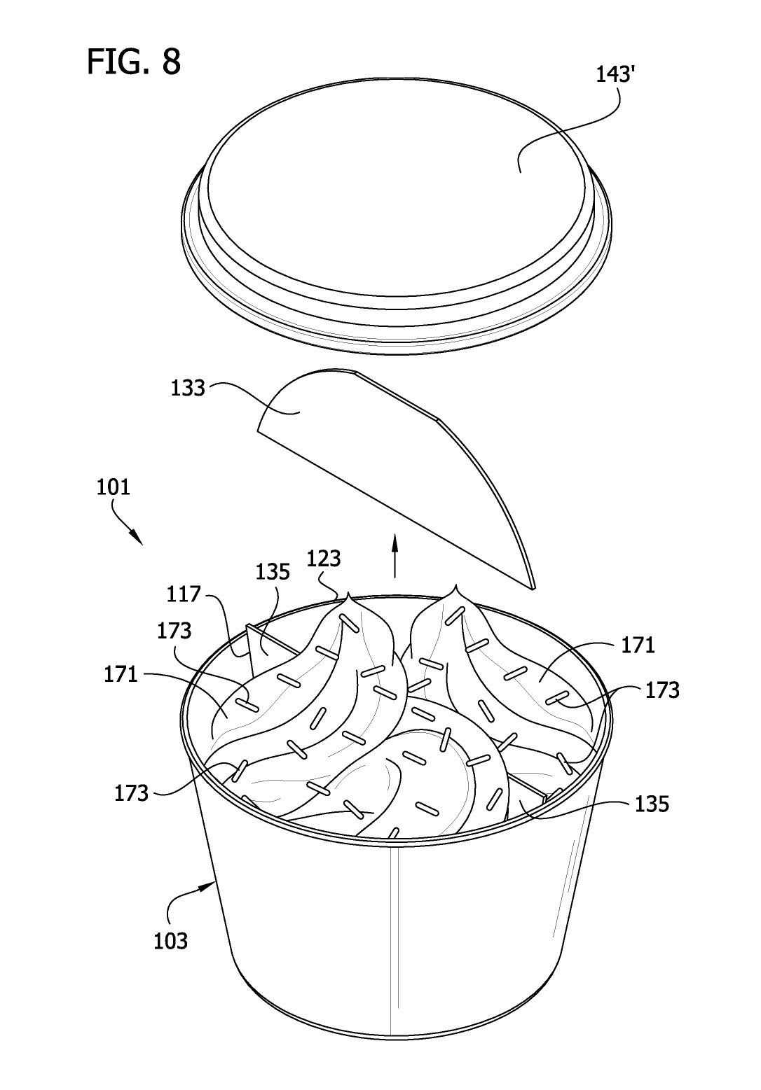

If desired, the divider 105 can be configured so the tear off portion 133 must be separated from the main body 135 in order to provide clearance for a lid 143′. For instance, in FIG. 8 the tear off portion 133 and lid 143′ are constructed so the consumer is required to detach the tear off portion from the body 135 of the divider to use the lid 143′. This encourages any consumers who want to use the lid 143′ to remove the tear off piece 133. This is desirable to the advertiser because the impact of any advertising/promotional materials associated with the tear off portion 133 is increased because of the physical interaction between the consumer and the tear off portion.

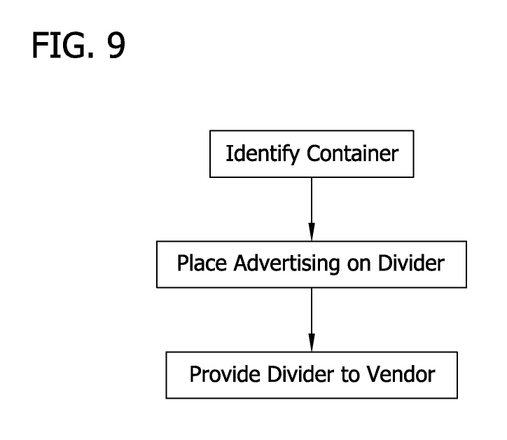

One embodiment of an advertising method of the present invention is outlined in FIG. 9. The method includes the step of identifying a container provided to a customer by a vendor of self-serve frozen desserts for use holding a frozen dessert. The vendor can be a self-serve vendor in which the frozen dessert is assembled by the customer, but this is not required. As used herein the term “self-serve vendor” includes not only vendors that allow customers to dispense the primary frozen dessert into the containers, but also vendors that serve customers a container already filled with a primary frozen dessert product and then allow the customers to apply one or more self-serve toppings. The container can be identified in various ways. For example, the identifying can be accomplished by receiving an order from a vendor for a particular divider such that the vendor's order implicitly or explicitly identifies a particular container configured for use with that particular divider. The container can also be identified by visiting the vendor's place of business to see what kind of container is being used or asking the vendor what kind of container is used at the vendor's establishment.

The method outlined in FIG. 9 also includes placing advertising on a flat divider. The advertising may be placed by a person wanting to do self-promotion of himself or herself or to promote his or her business interests. The advertising may also be placed on the divider for one or more third parties who pay fees in order to have their advertising placed on the divider. The divider is suitably configured to match a shape of the identified container such that the vendor's customer can place the divider into the container and divide it into two compartments. For example, if the identified container has the same shape as the cup 103 described above, the divider can be substantially identical to the divider 105 described above.

The method also includes providing the divider along with the advertising thereon to the vendor. The divider can be provided to the vendor pursuant to various business arrangements. For example, the divider can be sold to the vendor or given away to the vendor free of charge. It is also contemplated that providing the divider to the vendor can include paying the vendor (e.g., a portion of the fees collected from third parties to place the advertising on the divider). If the vendor is paid to accept the divider, the method may include paying the vendor to place the divider at a self-serve frozen yogurt dispensing station or at a station at which a customer may apply self-selected toppings so it can be accessed by the vendor's customers at the self-serve station.

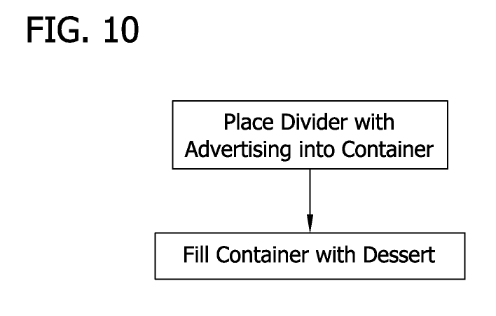

Another method of enhancing the impact of a brand message and associating the brand with a positive experience for at least one member of a target audience is outlined in FIG. 10. A flat divider 105 on which the brand message 111 is displayed is positioned in a container 103 so the container is divided into two compartments 107, e.g., as described above. The divider 105 is formed separately from the container 103 and is unable to support itself in an upright position. The container 103 is at least partially filled with a frozen dessert product so there is frozen dessert product in each compartment and the dessert product helps retain the divider in an upright position in the container. These steps can be performed by a customer/consumer of the dessert product, in which case the customer/consumer can be a member of the target audience for the brand message. Alternatively, one or both of the steps can be performed by a vendor in response to an order from the customer/consumer.

### EXAMPLE 1

An advertising broker identifies a container used by a vendor of frozen dessert products. The vendor can be a self-serve vendor and/or may provide already filled containers to customers in response to customer orders. The container can be identified by visiting the vendor's place of business and observing the containers. The broker could also identify the container by inspecting an order from the vendor, wherein the order conveys information about the container either explicitly or implicitly (e.g., as established in the course of previous dealings with the vendor making the order). The broker places advertising (e.g., pursuant to instructions from the broker's advertising clients) on a flat divider configured so the divider can be combined with the identified container to form an advertising unit as described above. Then the broker provides the dividers to the vendor and collects payment from the advertisers.

Various business arrangements can be made between the broker and the vendor depending on market conditions and desire of the parties. The broker can simply donate the dividers to the vendor with the hope this will result in the vendor providing the dividers to its customers. The broker can sell the dividers to the vendor, e.g., below cost. Another option is for the broker to pay the vendor (e.g., a percentage of the advertising revenue collected by the broker) for the privilege of having the vendor provide the dividers to its customers.

### EXAMPLE 2

A vendor of frozen desserts causes a supply of dividers to be constructed as described above. The vendor may place its own advertising and/or brand message on the divider or that of a related entity (e.g., without arm's length between the vendor and the entity that will benefit from the advertising). For example, the vendor may run a game or other promotion using the features of the divider described above. The vendor places the dividers where they are available for customers to use, for example at a self serve station, and/or places the dividers in containers and fills the containers with frozen dessert in response to customer orders. Optionally, various toppings are made available for the customer to place on top of the frozen dessert.

### EXAMPLE 3

A customer of a self-serve comestible product vendor takes a divider as described above from a supply of dividers provided by the vendor and places it in a container to divide the container into two compartments. The customer dispenses a comestible product (e.g., frozen yogurt) into each of the compartments. For example, the customer may dispense a different flavor of comestible product into each compartment. Optionally, the customer may add toppings to the product selected from a plurality of different toppings made available to the customer by the vendor.

1. An advertising unit comprising:
a container;
a flat divider dividing the container into two compartments, the divider being formed separately from the container and unable to support itself in an upright orientation, the divider including an advertising display; and
a comestible product in the container on opposite sides of the divider and supporting the divider in a generally upright position.

2. An advertising unit as set forth in claim 1 wherein the comestible product comprises a frozen dessert product.

3. An advertising unit as set forth in claim 2 wherein the frozen dessert product comprises at least one of the group consisting of ice cream, frozen yogurt, and frozen custard.

4. An advertising unit as set forth in claim 1 wherein the divider is configured to extend from a bottom of the container to a position above a top of the container.

5. An advertising unit as set forth in claim 4 further comprising a dome-shaped lid secured to the top of the container, wherein the divider has a top edge positioned adjacent the lid.

6. An advertising unit as set forth in claim 1 wherein the container has opposing inner sides and the divider has opposite sides in conformal engagement with at least segments of the inner sides of the container.

7. An advertising unit as set forth in claim 1 wherein the divider and cup are adapted to encourage a consumer to interact with the divider by allowing the divider to be moved relative to the container in response to incidental contact by the consumer as the consumer consumes the comestible product.

8. An advertising unit as set forth in claim 1 wherein the divider includes perforations separating a main body of the divider from a tear off portion of the divider.

9. An advertising unit as set forth in claim 8 wherein the tear off portion of the divider is adapted for use by the consumer as at least one of the following:
a piece in a promotional game or contest;
a proof of purchase for a rewards program;
a barcode; and
a coupon.

10. A method of advertising comprising:
identifying a container provided by a vendor of self-serve frozen desserts to a customer to use to hold a frozen dessert assembled by the customer;
placing advertising on a flat divider, the divider being unable to support itself in an upright orientation, the divider being configured to match a shape of the container such that the vendor's customer can place the divider into the container and divide it into two compartments and so the divider can be held in an upright position by the self-serve frozen dessert; and
providing the divider to the vendor.

11. A method as recited in claim 10 further comprising paying the vendor to place the divider at a self-serve frozen yogurt dispensing station and where it can be accessed by the vendor's customers.

12. A method as recited in claim 10 wherein providing the divider to the vendor comprises selling the divider to the vendor.

13. A method as recited in claim 10 wherein providing the divider to the vender comprises giving the divider to the vendor free of charge.

14. A method as recited claim 10 wherein the divider is configured to allow movement of the divider relative to the container as the frozen dessert is consumed by the customer to encourage the customer to interact with the divider.

15. A method as recited in claim 10 wherein the divider is configured to extend above a top of the container.

16. A method as recited in claim 10 wherein the divider includes perforations separating a main body of the divider from a tear off portion of the divider, the tear off portion of the divider being adapted for use by the customer as at least one of the following:
a game piece in a promotional game or contest;
a proof of purchase for a rewards program;
barcode; and
a coupon.

17. A method of enhancing the impact of a brand message and associating the brand with a positive experience for at least one member of a target audience for the brand message, the method comprising:
positioning a flat divider on which the brand message is displayed into a container so the divider divides the container into two compartments, the divider being formed separately from the container and unable to support itself in an upright position; and
at least partially filling the container with a frozen dessert product,
wherein after the placing and filling steps, frozen dessert product is in each of the compartments and helps retain the divider in an upright position in the container.

18. A method as set forth in claim 17 wherein the placing and filling steps are performed by a member of the target audience.

19. A method as recited in claim 17 wherein the filling step takes place at a self-serve dispensing station, the method further comprising placing a plurality of self-serve toppings adjacent the dispensing station.

20. (canceled)

21. A method as recited in claim 17 wherein the divider includes perforations separating a main body of the divider from a tear off portion of the divider, the tear off portion of the divider being adapted for use by the customer as at least one of the following:
a game piece in a promotional game or contest;
a proof of purchase for a rewards program;
barcode; and
a coupon.

22. (canceled)
